(19) United States
(12) Patent Application Publication
(10) Pub. No.: US 2002/0089479 A1
(43) Pub. Date: Jul. 11, 2002

(54) Liquid crystal display device

(76) Inventors: Eiji Sato, Nara (JP); Yasuhisa Itoh, Nara (JP); Tomoko Teranishi, Nara (JP)

Correspondence Address: David G. Conlin, Esq., Dike, Bronstein, Roberts & Cushman IP Group, Edwards & Angell, LLP, 130 Water Street, Boston, MA, 02109, US

(21) Appl. No.: 10/039,309

(22) Filed: Nov. 7, 2001

(30) Foreign Application Priority Data
Nov. 9, 2000 (JP) 2000-342357

(51) Int. Cl. G09G 3/36

(52) U.S. Cl. 345/87

(57) ABSTRACT

The liquid crystal display device of the present invention includes: a liquid crystal layer; a pair of substrates provided so as to interpose the liquid crystal layer therebetween; and a plurality of pixels arranged in a matrix pattern. The liquid crystal layer has a helical structure and exhibits at least two stable states including a planar state and a focal conic state according to an applied voltage. In each of the plurality of pixels, a thickness d of the liquid crystal layer has at least two different values, and the liquid crystal layer includes at least two regions having different values of a first threshold voltage for transitioning the liquid crystal layer from the planar state to the focal conic state.

### BACKGROUND OF THE INVENTION

1. Field of the Invention

The present invention relates to a liquid crystal display device, and more particularly to a liquid crystal display device including a liquid crystal layer having a helical structure.

2. Description of the Background Art

In recent years, liquid crystal display devices, having desirable characteristics such as a small thickness and a small power consumption, have been widely used in various applications, including OA equipment such as word processors and personal computers, PDAs (personal digital assistance) such as electronic organizers, and camcorders with liquid crystal monitors. Particularly, reflection type liquid crystal display devices have been actively developed recently as they can be advantageously used outdoors in addition to other advantages such as the high portability and the low power consumption.

However, despite the number of advantages, reflection type liquid crystal display devices that are commercially available at present have a poor reflectance (the ratio of the reflected light intensity to the incident light intensity), and the visibility thereof lowers significantly with relatively dark ambient light.

A primary factor for the poor reflectance is the use of one or two polarizers in any type of reflection type liquid crystal display devices that are commercially available at present, whereby 50% or more of the incident light is absorbed and wasted by the polarizers and thus is not used for display.

In view of this, reflection type liquid crystal display devices that do not use polarizers have been proposed in the art, in which a liquid crystal layer that selectively reflects light of a particular wavelength region (a liquid crystal layer having a helical structure such as a cholesteric liquid crystal layer) is used.

The phenomenon in which a cholesteric liquid crystal layer selectively reflects light of a wavelength corresponding to the helical pitch thereof is described in various articles, including Appl. Opt. Vol. 7, No. 9, p. 1729 (1968), and Phys. Rev. Vol. 5, No. 9, p. 577 (1970).

For example, a clockwise cholesteric liquid crystal layer selectively reflects clockwise circularly-polarized light having a wavelength λ in the range of no·p<λ<ne·p, while transmitting clockwise circularly-polarized light of any other wavelength and counterclockwise circularly-polarized light of any wavelength. Herein, no and ne denote the refractive index of the liquid crystal layer for ordinary light and that for extraordinary light, respectively, p denotes the helical pitch, and λ denotes the reflection wavelength. The mean reflection wavelength λ m is represented by λ m=na·p, where na denotes the average refractive index of the liquid crystal layer. A counterclockwise cholesteric liquid crystal layer, on the other hand, selectively reflects only counterclockwise circularly-polarized light in a particular wavelength region, in contrast to the case of a clockwise cholesteric liquid crystal layer.

Such liquid crystal layers selectively reflecting light in a particular wavelength region include, in addition to the cholesteric liquid crystal layer, a chiral nematic liquid crystal layer obtained by adding an optically active chiral agent to a normal nematic liquid crystal material, a chiral smectic liquid crystal layer, etc. While a cholesteric liquid crystal layer has a poor reliability as it is generally instable to stimulus from an atmosphere or UV light, a chiral nematic liquid crystal layer has a desirable light resistance, a high stability, a relatively high degree of ease in adjusting the helical pitch thereof, ease in adjusting the width of the wavelength region in which light is selectively reflected (hereinafter referred to as the “selective reflection region”), and a wide selection of materials. Therefore, a chiral nematic liquid crystal layer is typically employed in commercial use.

In a liquid crystal display device with such a liquid crystal layer, the orientation of the liquid crystal layer changes as follows in response to voltage application across the liquid crystal layer. First, in the absence of an applied voltage, the liquid crystal layer is in a planar state in which the helical axis is perpendicular to the substrate. Upon application of a voltage greater than a predetermined threshold value, the liquid crystal layer takes a focal conic state in which the helical axis orientation is random (or substantially parallel) with respect to the substrate.

When the liquid crystal layer described above has its selective reflection region in the visible light region, it reflects visible light in the planar state while transmitting visible light in the focal conic state. Therefore, a liquid crystal display device provided with the liquid crystal layer described above functions as a reflection liquid crystal display device capable of displaying an image by switching the optical characteristic of the liquid crystal layer between a selective reflection mode and a transmission mode by turning ON/OFF the voltage application.

When the liquid crystal layer described above does not have its selective reflection region in the visible light region, but in the infrared region, for example, it transmits visible light in the planar state while scattering visible light in the focal conic state. Therefore, a liquid crystal display device provided with the liquid crystal layer described above functions as a reflection liquid crystal display device capable of displaying an image by switching the optical characteristic of the liquid crystal layer between a transmission mode and a scattering mode by turning ON/OFF the voltage application.

Moreover, the liquid crystal layer described above is stable both in the planar state and in the focal conic state. Due to such a bistability, the liquid crystal layer described above has a memory property, whereby the orientation obtained by a voltage applied during a writing operation is retained even after the removal of the voltage.

However, in a liquid crystal display device as described above, it is difficult to stably control an intermediate state between the planar state and the focal conic state, and it is difficult to perform an intermediate gray level display or a multiple gray level display.

In order to solve the problem, Japanese Laid-Open Patent Publication No. 10-307288 discloses a method in which a plurality of resin walls are formed in each pixel region so as to provide, in each pixel, a plurality of regions that are different from one another in terms of at least one of the density, the arrangement pitch and the shape of the resin walls.

In the liquid crystal display device disclosed in this publication, resin walls are formed in the pixel region, whereby the movement of the liquid crystal molecules is restricted by their interaction with the resin walls. Therefore, the degree to which the movement of the liquid crystal molecules is restricted by their interaction with the resin walls varies among different regions differing from one another in terms of the density, the arrangement pitch or the shape of the resin walls.

As a result, in the liquid crystal display device disclosed in the publication above, each pixel has a plurality of regions differing from one another in terms of the effective threshold voltage, whereby it is possible to perform an intermediate gray level display or a multiple gray level display.

However, in the liquid crystal display device disclosed in Japanese Laid-Open Patent Publication No. 10-307288, the resin walls are formed through a photopolymerization reaction and a phase separation process, thus complicating the production process. Moreover, the resin walls being formed in the pixel region reduce the aperture ratio and the contrast ratio.

### SUMMARY OF THE INVENTION

The present invention has been made in view of the problems described above, and has an object to provide a liquid crystal display device capable of performing an intermediate gray level display and a multiple gray level display.

A liquid crystal display device of the present invention includes: a liquid crystal layer; a pair of substrates provided so as to interpose the liquid crystal layer therebetween; and a plurality of pixels arranged in a matrix pattern, wherein: the liquid crystal layer has a helical structure and exhibits at least two stable states including a planar state and a focal conic state according to an applied voltage; and in each of the plurality of pixels, a thickness d of the liquid crystal layer has at least two different values, and the liquid crystal layer includes at least two regions having different values of a first threshold voltage for transitioning the liquid crystal layer from the planar state to the focal conic state. Thus, the object described above is realized.

It is preferred that the thickness d of the liquid crystal layer satisfies a relationship of 1<d/P<15 with a helical pitch P of the helical structure.

It is preferred that the thickness d of the liquid crystal layer is defined so that VthFmax is less than VthHmin in each of the plurality of pixels, where VthFmax denotes the first threshold voltage for transitioning the liquid crystal layer included in a region of the liquid crystal layer with a largest thickness d from the planar state to the focal conic state, and VthHmin denotes a second threshold voltage for transitioning the liquid crystal layer included in a region of the liquid crystal layer with a smallest thickness d from the focal conic state to a homeotropic state.

A value of the thickness d of the liquid crystal layer may change discontinuously across each of the plurality of pixels.

It is preferred that a difference Δd between the at least two different values of the thickness d of the liquid crystal layer satisfies a relationship of 0.5 P≦Δd with the helical pitch P of the helical structure.

A value of the thickness d of the liquid crystal layer may change continuously across each of the plurality of pixels.

It is preferred that the liquid crystal display device further includes a pair of alignment layers provided respectively on the pair of substrates on one side thereof that is closer to the liquid crystal layer, wherein one of the pair of alignment layers is a horizontal alignment layer, and the other one of the pair of alignment layers is a vertical alignment layer.

At least one of the pair of substrates may include a concave/convex surface on one side thereof that is closer to the liquid crystal layer.

It is preferred that the pair of substrates both include a concave/convex surface on one side thereof that is closer to the liquid crystal layer.

The function of the present invention is as follows.

In the liquid crystal display device of the present invention, each of a plurality of pixels has at least two different values for the thickness d of the liquid crystal layer, and the liquid crystal layer has at least two regions differing from one another in terms of the value of the first threshold voltage for transitioning the liquid crystal layer from the planar state to the focal conic state. Therefore, it is possible to transition the liquid crystal layer included in one region in a pixel to the focal conic state while maintaining the liquid crystal layer included in another region in the same pixel in the planar state. As a result, it is possible to realize an intermediate gray level display and a multiple gray level display based on an area coverage modulation method by using a liquid crystal layer having a helical structure and exhibiting at least two stable states (bistability), including the planar state and the focal conic state, according to the voltage applied thereacross.

### BRIEF DESCRIPTION OF THE DRAWINGS

FIG. 1 is a cross-sectional view schematically illustrating a liquid crystal display device 100 according to Embodiment 1 of the present invention.

FIG. 2 is a diagram schematically illustrating an orientation of a liquid crystal layer in the liquid crystal display device 100 according to Embodiment 1 of the present invention in the presence of a predetermined voltage applied thereacross.

FIGS. 3A, 3B and 3C are cross-sectional views schematically illustrating the process of producing a resin layer of the liquid crystal display device 100 according to Embodiment 1 of the present invention.

FIG. 4 is a graph illustrating the reflectance of a pixel in the liquid crystal display device 100 according to Embodiment 1 of the present invention with respect to the applied voltage.

FIG. 5 is a diagram schematically illustrating a method of measuring the reflectance of a liquid crystal display device of the present invention.

FIG. 6 is a graph illustrating the reflectance of a pixel in the liquid crystal display device 100 according to Embodiment 1 of the present invention with respect to the applied voltage.

FIG. 7 is a cross-sectional view schematically illustrating an alternative arrangement of the liquid crystal display device 100 according to Embodiment 1 of the present invention.

FIG. 8 is a diagram schematically illustrating a photomask 42 used in the process of producing the alternative arrangement of the liquid crystal display device 100 according to Embodiment 1 of the present invention.

FIG. 9 is a cross-sectional view schematically illustrating a liquid crystal display device 200 according to Embodiment 2 of the present invention.

FIG. 10 is a graph illustrating the reflectance of a pixel in the liquid crystal display device 200 according to Embodiment 2 of the present invention with respect to the applied voltage.

FIG. 11 is a graph illustrating the reflectance of a pixel in the liquid crystal display device 200 according to Embodiment 2 of the present invention with respect to the applied voltage.

FIGS. 12A, 12B and 12C schematically illustrate a liquid crystal display device 300 according to Embodiment 3 of the present invention, wherein FIG. 12A is a cross-sectional view, FIG. 12B is a perspective view, and FIG. 12C is a top view.

### DETAILED DESCRIPTION OF THE PREFERRED EMBODIMENTS

Liquid crystal display devices according to various embodiments of the present invention will now be described with reference to the drawings. Note that the present invention is not limited to the following embodiments.

Embodiment 1

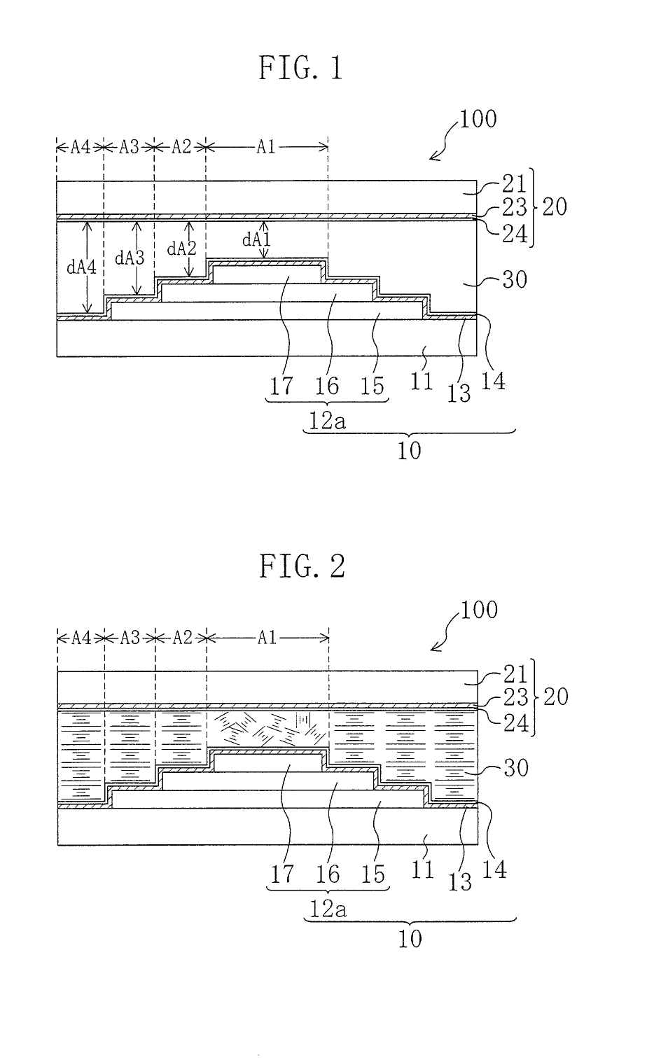

FIG. 1 schematically illustrates a liquid crystal display device 100 according to Embodiment 1 of the present invention. The liquid crystal display device 100 includes a plurality of pixels arranged in a matrix pattern, and FIG. 1 is a cross-sectional view schematically illustrating a one-pixel portion of the liquid crystal display device 100.

The liquid crystal display device 100 is a reflection type liquid crystal display device including a liquid crystal layer 30, and a first substrate 10 and a second substrate 20 interposing the liquid crystal layer 30 therebetween. The liquid crystal display device 100 displays an image by using ambient light that is incident thereupon from the second substrate 20 side.

The first substrate 10 includes a resin layer 12a formed in a stepped pattern on an insulative substrate 11, a pixel electrode 13 formed so as to cover the resin layer 12a, and an alignment layer 14 formed on the pixel electrode 13.

The second substrate 20 opposing the first substrate 10 includes a counter electrode 23 formed on a transparent substrate 21, and an alignment layer 24 formed on the counter electrode 23.

The liquid crystal layer 30 may be a liquid crystal layer having a helical structure, such as a cholesteric liquid crystal layer, a chiral nematic liquid crystal layer or a chiral smectic liquid crystal layer. In the present embodiment, a chiral nematic liquid crystal layer is used as the liquid crystal layer 30 for the desirable light resistance, the high stability, the ease in adjusting the helical pitch thereof, the ease in adjusting the width of the selective reflection region, and the wide selection of materials. Of course, a cholesteric liquid crystal layer or a chiral smectic liquid crystal layer may alternatively be used.

The liquid crystal layer 30 exhibits two stable states, including the planar state in which the helical axis is perpendicular to the substrate and the focal conic state in which the helical axis orientation is random (or substantially parallel) with respect to the substrate. The liquid crystal layer 30 transitions from the planar state to the focal conic state upon application of a voltage equal to or greater than a predetermined first threshold voltage. The liquid crystal layer 30 is stable (bistable) both in the planar state and in the focal conic state. Due to such a bistability, the liquid crystal layer 30 described above has a memory property, whereby the orientation obtained by a voltage applied during a writing operation is retained even after the removal of the voltage.

The liquid crystal layer 30 has different optical characteristics between when it is exhibiting the planar state and when it is exhibiting the focal conic state. Specifically, when the selective reflection region of the liquid crystal layer 30 in the planar state is set to be in the visible light region, for example, the liquid crystal layer 30 selectively reflects visible light in the planar state while transmitting visible light in the focal conic state. When the selective reflection region is set to be in the infrared region, the liquid crystal layer 30 transmits visible light in the planar state while scattering visible light in the focal conic state.

In the liquid crystal display device 100 of the present invention, each of a plurality of pixels has a plurality of different values for the thickness d of the liquid crystal layer 30, and the liquid crystal layer 30 has a plurality of regions differing from one another in terms of the value of the first threshold voltage for transitioning the liquid crystal layer 30 from the planar state to the focal conic state. Therefore, it is possible to transition the liquid crystal layer included in one region in a pixel to the focal conic state while maintaining the liquid crystal layer included in another region in the same pixel in the planar state. As a result, it is possible to realize an intermediate gray level display and a multiple gray level display based on an area coverage modulation method.

This will now be described in greater detail.

It has been experimentally confirmed by the present inventors that the value of the threshold voltage for transitioning the liquid crystal layer 30 from the planar state to the focal conic state depends on the thickness d of the liquid crystal layer 30. More strictly, the value of the first threshold voltage increases as the value of the number of helical turns d/P increases, where P denotes the helical pitch of the helical structure of the liquid crystal layer 30, and is represented by VthF=a·(d/P)+b, where VthF denotes the first threshold voltage, and a and b are constants that are dictated by the liquid crystal material and the alignment treatment used.

As illustrated in FIG. 1, the liquid crystal display device 100 of the present invention includes, in each pixel, regions A1, A2, A3 and A4 having different thicknesses. The respective thicknesses d_{A1}, d_{A2}, d_{A3} and d_{A4} of the regions A1, A2, A3 and A4 satisfy the relationship of d_{A1}<d_{A2}<d_{A3}<d_{A4}.

The thicknesses d_{A1}, d_{A2}, d_{A3} and d_{A4} of the liquid crystal layer are defined so as to satisfy the relationship of VthF_{A1}<VthF_{A2}<VthF_{A3}<VthF_{A4}, where VthF_{A1}, VthFA_{A2}, VthF_{A3} and VthF_{A4} denote the first threshold voltages in the regions A1, A2, A3 and A4, respectively.

The liquid crystal layer 30 including a plurality of regions having different first threshold voltages as described above changes its orientation as follows in response to a voltage applied thereacross.

First, when no voltage (or a voltage less than Vth_{A1}) is applied across the liquid crystal layer 30, the liquid crystal layer 30 is in the planar state in all regions of the pixel.

When a voltage equal to or greater than Vth_{A1} and less than Vth_{A2} is applied across the liquid crystal layer 30, the liquid crystal layer 30 included in the region A1 transitions from the planar state to the focal conic state, as illustrated in FIG. 2. FIG. 2 is a diagram schematically illustrating the orientation of liquid crystal molecules in a pixel of the liquid crystal display device 100. The liquid crystal layer 30 included in the regions A2, A3 and A4 remains in the planar state, as illustrated in FIG. 2.

When a voltage equal to or greater than Vth_{A2} and less than Vth_{A3} is applied across the liquid crystal layer 30, the liquid crystal layer 30 included in the regions A1 and A2 transitions to the focal conic state, and the liquid crystal layer 30 included in the regions A3 and A4 remains in the planar state.

When a voltage equal to or greater than Vth_{A3} and less than Vth_{A4} is applied across the liquid crystal layer 30, the liquid crystal layer 30 included in the regions A1, A2 and A3 transitions to the focal conic state, and the liquid crystal layer 30 included in the region A4 remains in the planar state.

When a voltage equal to or greater than Vth_{A4} is applied across the liquid crystal layer 30, the liquid crystal layer 30 in all regions of the pixel transitions to the focal conic state.

As described above, in the liquid crystal display device 100 of the present invention, it is possible to apply a predetermined voltage across the liquid crystal layer 30 included in one pixel so as to transition the liquid crystal layer 30 included in one region of the pixel to the focal conic state while maintaining the liquid crystal layer 30 included in another region of the pixel in the planar state.

Therefore, the reflectance for light in the visible light range in the pixel (hereinafter “the reflectance for light in the visible light range” will be referred to simply as “the reflectance”) can be set to a value between the reflectance value obtained when the liquid crystal layer in all regions of the pixel is in the planar state and the reflectance value obtained when the liquid crystal layer in all regions of the pixel is in the focal conic state. The reflectance as defined above can be controlled by changing the area ratio between the area exhibiting the planar state and the area exhibiting the focal conic state by controlling the voltage to be applied across the liquid crystal layer 30. As a result, it is possible to realize an intermediate gray level display and a multiple gray level display based on an area coverage modulation method.

For example, the liquid crystal display device 100 may be produced as follows.

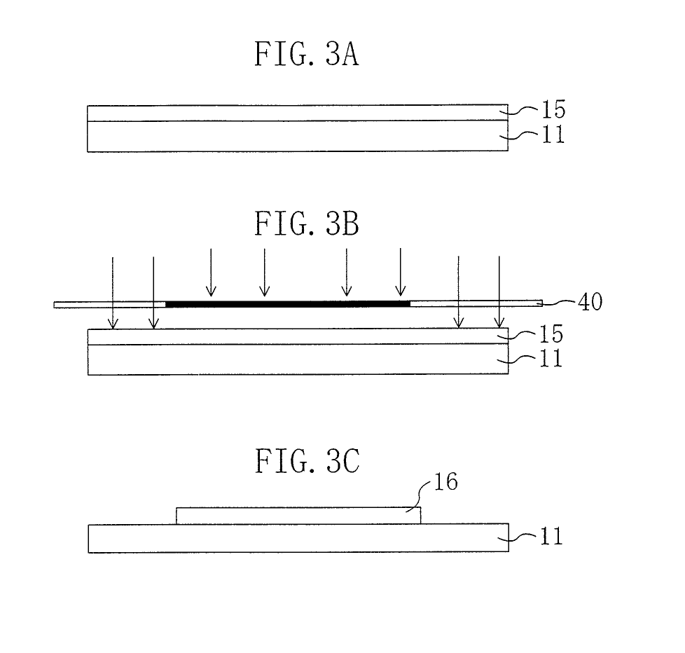

First, as illustrated in FIG. 3A, a positive type photosensitive resin (e.g., OFPR-800 manufactured by Tokyo Ohka Kogyo Co., Ltd.) 15 to be a first resin layer 16 is applied to a desired thickness by a spin coat method on the insulative substrate (e.g., a glass substrate) 11. Then, an exposure process is performed with a photomask 40 placed as illustrated in FIG. 3B. The shape of the light blocking portion of the photomask 40 may be determined according to the desired shape of the first resin layer 16 (the shape as viewed in the substrate normal direction), and is typically a circular shape or a polygonal shape. Then, a development process is performed by using a development solution (e.g., TMAH (tetramethyl ammonium hydroxide) manufactured by Tokyo Ohka Kogyo Co., Ltd.), followed by a baking process at about 200° C. for about 1 hour, thus obtaining the first resin layer 16 as illustrated in FIG. 3C. In the present embodiment, the first resin layer 16 is formed to have a thickness of about 3 μm.

Then, a second resin layer 17 and a third resin layer 18 are deposited on the first resin layer 16 by a similar method, thereby obtaining the stepped resin layer 12a. In the present embodiment, the second resin layer 17 and the third resin layer 18 are each formed to have a thickness of about 3 μm. The shape of each of the first resin layer 16, the second resin layer 17 and the third resin layer 18 (as viewed in the substrate normal direction) may be determined as desired, and is typically a circular shape or a polygonal shape. While the resin layer 12 a is formed by using a positive type photosensitive resin in the present embodiment, a negative type photosensitive resin may of course be used alternatively.

Then, the pixel electrode (e.g., an ITO film) 13 is formed to a thickness of about 100 nm by a sputtering method on the insulative substrate 11 so as to cover the resin layer 12a. Then, the horizontal alignment layer (e.g., OPTMER AL-4552 manufactured by JSR Corporation) 14 is formed to a thickness of about 50 nm by a spin coat method, and the horizontal alignment layer 14 is subjected to a rubbing treatment. The first substrate 10 is obtained as described above. While the alignment treatment is performed by a rubbing treatment in this example, the alignment treatment is not limited to this, but may be any other type of alignment treatment as long as a desired alignment force is obtained. For example, the alignment treatment may be performed by an oblique deposition method using an oxide such as SiO, or an optical alignment method using polarized UV light.

Then, the second substrate 20 is produced as follows. First, the counter electrode (e.g., an ITO layer) 23 is formed to a thickness of about 100 nm by a sputtering method on the transparent substrate (e.g., a glass substrate) 21. Then, the horizontal alignment layer (e.g., OPTMER AL-4552 manufactured by JSR Corporation) 24 is formed to a thickness of about 50 nm by a spin coat method on the counter electrode 23, and the horizontal alignment layer 24 is subjected to a rubbing treatment. Thus, the second substrate 20 is obtained.

Then, a spacer is placed in regions of the first substrate 10 where the resin layer 12a is not formed, and the first substrate 10 and the second substrate 20 are attached to each other. In the present embodiment, the first substrate 10 and the second substrate 20 are attached to each other so that the cell gap in regions where the resin layer 12a is not formed is about 15 μm.

Then, a liquid crystal material is injected into a gap between the first substrate 10 and the second substrate 20 attached together, thus forming the liquid crystal layer 30. In the present embodiment, the material of the liquid crystal layer 30 may be a chiral nematic liquid crystal material obtained by mixing a nematic liquid crystal material E7 (manufactured by Merck & Co., Inc.) with about 8.9 wt % of a chiral agent S-811 (manufactured by Merck & Co., Inc.), in which the spontaneous helical pitch of the helical structure is about 1.1 μm and the selective reflection region is set to be in the infrared region.

In the present embodiment, the first substrate 10 is provided with a light absorbing layer (not shown) for absorbing light in the visible light region so that a black display is produced when the liquid crystal layer 30 in all regions of the pixel is exhibiting the planar state. The light absorbing layer may be provided on the outer side (the side away from the liquid crystal layer 30 ) of the insulative substrate 11 or between the insulative substrate 11 and the pixel electrode 13. Of course, the pixel electrode 13 may be formed by using a light absorbing material such as an organic conductive material with a pigment dispersed therein so that the pixel electrode 13 functions as a light absorbing layer.

The first resin layer 16, the second resin layer 17 and the third resin layer 18 together forming the resin layer 12a each have a thickness of about 3 μm. Accordingly, the liquid crystal layer 30 include, in each pixel, the regions A1, A2, A3 and A4 in which the thickness of the liquid crystal layer 30 is about 6 μm, about 9 μm, about 12 μm and about 15 μm, respectively. Thus, in the present embodiment, the thicknesses of the liquid crystal layer 30 in the regions A1, A2, A3 and A4 are substantially defined by the first resin layer 16, the second resin layer 17 and the third resin layer 18. The shape and the area of these regions are also substantially defined by the first resin layer 16, the second resin layer 17 and the third resin layer 18.

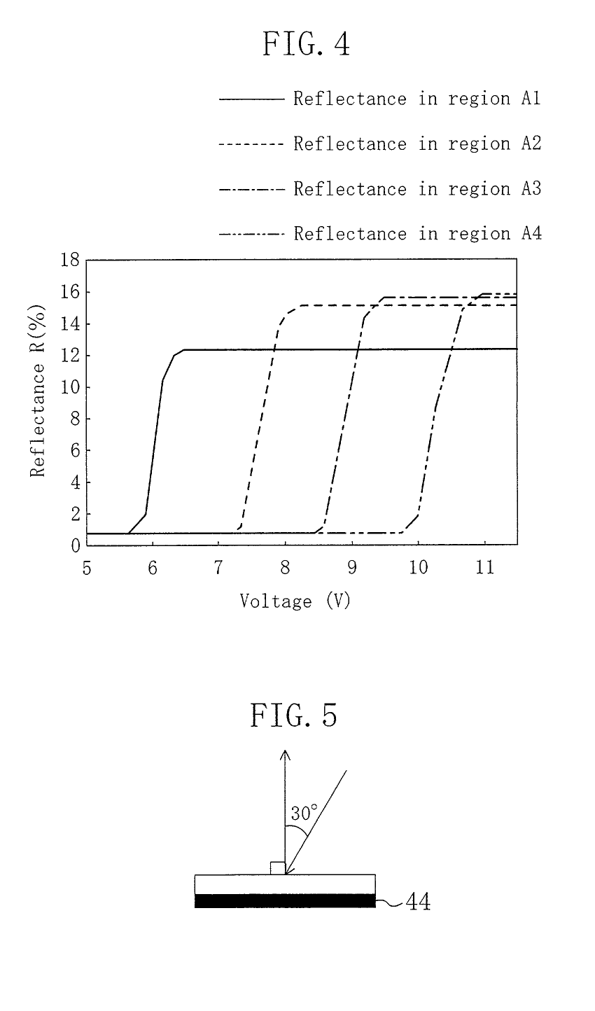

The liquid crystal display device 100 is obtained as described above. FIG. 4 is a graph illustrating the reflectance of the liquid crystal display device 100 thus obtained in the regions A1, A2, A3 and A4 along the vertical axis, and the voltage applied across the liquid crystal layer 30 along the horizontal axis. The reflectance values in FIG. 4 are measured by producing liquid crystal display devices whose liquid crystal layer has a thickness of about 6 μm, about 9 μm, about 12 μm and about 15 μm, respectively, providing light to be incident thereupon at an angle of about 30° with respect to the substrate normal direction, and receiving the reflected light in the substrate normal direction, as illustrated in FIG. 5. A black absorbing plate 44 provided as a light absorbing layer on the reverse side of the liquid crystal display device is matched with the substrate by using a silicone oil, and a pulse voltage of 100 ms, 10 kHz is used as the applied voltage. The reflectance values are obtained with respect to a reflectance value measured with an MgSO₄ standard white board being 100%.

As illustrated in FIG. 4, the liquid crystal layer 30 of the liquid crystal display device 100 has different first threshold voltages for the regions A1, A2, A3 and A4. The orientation and the optical characteristic of the liquid crystal layer 30 change as follows by controlling the voltage to be applied across the liquid crystal layer 30.

First, when no voltage is applied across the liquid crystal layer 30, the liquid crystal layer 30 is in the planar state and thus transmits incident visible light in all regions of the pixel.

When a voltage of about 6 V is applied across the liquid crystal layer 30, the liquid crystal layer 30 included in the region A1 transitions to the focal conic state and thus scatters incident visible light, and the liquid crystal layer 30 included in the regions A2, A3 and A4 remains in the planar state and thus transmits incident visible light.

When a voltage of about 7.4 V is applied across the liquid crystal layer 30, the liquid crystal layer 30 included in the regions A1 and A2 transitions to the focal conic state and thus scatters incident visible light, and the liquid crystal layer 30 included in the regions A3 and A4 remains in the planar state and thus transmits incident visible light.

When a voltage of about 8.8 V is applied across the liquid crystal layer 30, the liquid crystal layer 30 included in the regions A1, A2 and A3 transitions to the focal conic state and thus scatters incident visible light, and the liquid crystal layer 30 included in the region A4 remains in the planar state and thus transmits incident visible light.

When a voltage of about 10.2 V is applied across the liquid crystal layer 30, the liquid crystal layer 30 in all regions of the pixel transitions to the focal conic state and thus scatters visible light.

As described above, in the liquid crystal display device 100 of the present invention, the liquid crystal layer 30 has four different values for the first threshold voltage in each pixel, and thus is capable of performing a five gray level display. Typically, an (n+1) gray level display is realized when the liquid crystal layer has n different values for the first threshold voltage in each pixel.

In the liquid crystal display device 100 of the present invention, the reflectance R in a pixel is represented by R=(Rp·Sp+Rf·Sf)/(Sp+Sf), where Sp and Rp denote the area and the reflectance, respectively, of the region of the liquid crystal layer 30 that is in the planar state, and Sf and Rf denote the area and the reflectance, respectively, of the region of the liquid crystal layer 30 that is in the focal conic state. Therefore, the value of the reflectance R for each gray level can be controlled by appropriately setting the area ratio among a plurality of regions of the liquid crystal layer 30 having different thicknesses. Table 1 below shows the values of the reflectance R in a pixel of the liquid crystal display device 100 for different applied voltages. In Table 1, the area of a pixel is 4, and the area of each of the regions A1, A2, A3 and A4 is 1.

TABLE 1

| Applied | | | | Sp | Reflectance R |
|---|---|---|---|---|---|
| voltage (V) | Rf (%) | Sf (%) | Rp (%) | (%) | (%) |
| 0 | 0.5 | 0 | 0.5 | 4 | 0.5 |
| 6.0 | 12.0 | 1 | 0.5 | 3 | 3.3 |
| 7.4 | 15.0 | 2 | 0.5 | 2 | 7.0 |
| 8.8 | 15.5 | 3 | 0.5 | 1 | 10.8 |
| 10.2 | 16.0 | 4 | 0.5 | 0 | 14.6 |

In the liquid crystal display device 100 including the liquid crystal layer 30 having a helical structure, it is preferred that the thickness d of the liquid crystal layer 30 satisfies the relationship of 1<d/P<15 with the helical pitch P of the helical structure.

When d/P≦1, the selective reflection intensity in the planar state and the scattering intensity in the focal conic state are excessively weak, thereby undesirably reducing the contrast ratio. Where the alignment layers provided on the opposing sides of the liquid crystal layer are both a vertical alignment layer, the liquid crystal layer does not form a helical structure if d/P≦1.

When d/P≦15, the driving voltage undesirably increases for the following reason.

In the liquid crystal display device 100 of the present invention, when the liquid crystal layer 30, which has been transitioned from the planar state to the focal conic state, is transitioned back to the planar state, a voltage equal to or greater than a second threshold voltage that is greater than the first threshold voltage is applied so that the liquid crystal layer 30 once transitions from the focal conic state to a homeotropic state. In the homeotropic state, the helical structure of the liquid crystal layer 30 is unwound so that the liquid crystal molecules are aligned vertical to the substrate.

When the second threshold voltage described above is denoted by VthH, the second threshold voltage VthH is proportional to d/P and is represented by VthH=d·(π²/P)·(k₂₂/(∈₀·Δ∈)) ½, where P is the helical pitch in the absence of an applied voltage (the planar state), k₂₂ is the twist elastic modulus of the liquid crystal material, ∈₀ is the dielectric constant of vacuum, and Δ∈ is the relative dielectric constant anisotropy.

While a liquid crystal display device includes a driver for applying a voltage across the liquid crystal layer 30, drivers for applying voltages greater than 40 V are expensive, thereby increasing the production cost of the liquid crystal display device. Therefore, it is preferred that the second threshold voltage is 40 V or less. It has been experimentally confirmed by the present inventors that the second threshold voltage is 40 V or less if d/P<15 in the liquid crystal display device 100 using the materials described above.

In order to produce a display with a high contrast ratio, it is preferred that the thickness d of the liquid crystal layer 30 is defined so that VthFmax (the first threshold voltage for transitioning the liquid crystal layer 30 included in a region with the largest thickness d of the liquid crystal layer 30 from the planar state to the focal conic state) is less than VthHmin (the second threshold voltage for transitioning the liquid crystal layer 30 included in a region with the smallest thickness d of the liquid crystal layer 30 from the focal conic state to the homeotropic state) in each of the plurality of pixels.

When the thickness d of the liquid crystal layer 30 is defined as described above, the liquid crystal layer in all regions in each pixel can exhibit the focal conic state by applying a predetermined voltage, specifically a voltage equal to or greater than VthFmax and less than VthHmin, across the liquid crystal layer 30. Therefore, it is possible to realize a display with a high contrast ratio. This will now be described in greater detail.

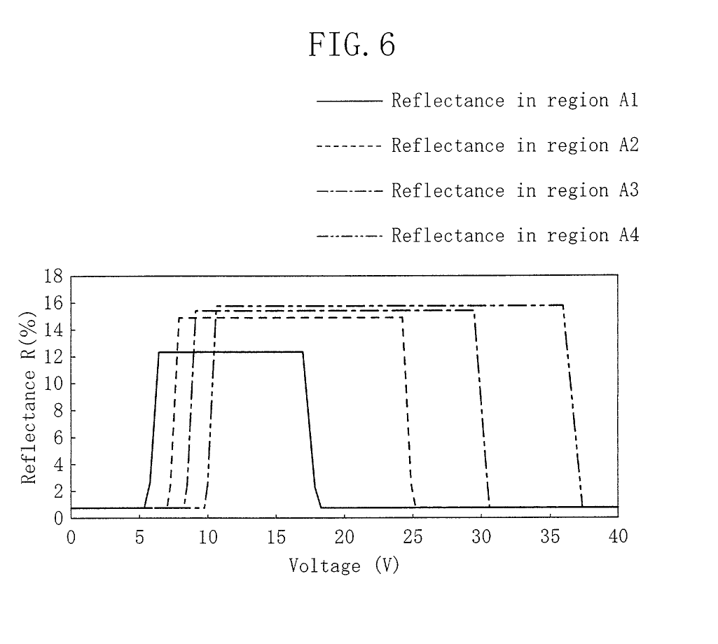

FIG. 6 is a graph illustrating the reflectance of the liquid crystal display device 100 of the present embodiment in the regions A1, A2, A3 and A4 along the vertical axis, and the voltage applied across the liquid crystal layer 30 along the horizontal axis. As illustrated in FIG. 6, the liquid crystal layer 30 of the liquid crystal display device 100 has different first threshold voltages and different second threshold voltages in the regions A1, A2, A3 and A4, with the first threshold voltage in the region A4 corresponding to VthFmax as defined above, and the second threshold voltage in the region A1 corresponding to VthHmin as defined above.

As can be seen from FIG. 6, in the liquid crystal display device 100, VthFmax is less than VthHmin. Therefore, by applying a voltage equal to or greater than VthFmax and less than VthHmin, specifically a voltage in a range of about 11 V to about 16 V, the liquid crystal layer 30 in all regions in a pixel can exhibit the focal conic state, whereby the liquid crystal layer 30 in all regions in the pixel scatters visible light. In the absence of an applied voltage and in the presence of an applied voltage of about 5 V or less, the liquid crystal layer 30 in all regions in the pixel is in the planar state, whereby the liquid crystal layer 30 in all regions in the pixel transmits visible light. Therefore, it is possible to obtain a large difference between the reflectance value in the brightest state and that in the darkest state for each pixel, whereby it is possible to realize a display with a high contrast ratio.

In the liquid crystal display device 100 of the present embodiment, the stepped resin layer 12a is provided on the first substrate 10, as illustrated in FIG. 1, and thus the value of the thickness d of the liquid crystal layer 30 changes discontinuously across a pixel. With such an arrangement where the value of the thickness d of the liquid crystal layer 30 changes discontinuously, it is easy to obtain a large difference between the value of the first threshold voltage in a region in a pixel having a thickness d and that in another region in the same pixel having a different thickness d. Therefore, it is easy to transition the liquid crystal layer 30 to the focal conic state only in a desired region despite the possible error in the voltage applied across the liquid crystal layer 30. As a result, it is possible to more reliably obtain a desired reflectance value.

With the structure as described above where the value of the thickness d of the liquid crystal layer 30 changes discontinuously, it is preferred that the difference Δd between different thicknesses d of the liquid crystal layer 30 satisfies the relationship of 0.5 P≦Δd with the helical pitch P of the helical structure for the following reason.

When a horizontal alignment layer is provided on both sides of the liquid crystal layer, as in the liquid crystal display device 100 of the present embodiment, the liquid crystal molecules in the vicinity of the upper surface of the liquid crystal layer and those in the vicinity of the lower surface of the liquid crystal layer are each aligned in a particular azimuth angle direction according to the orientation-regulating force from the respective one of the horizontal alignment layers. The direction of the orientation-regulating force of a horizontal alignment layer is typically defined by the rubbing treatment.

As described above, the liquid crystal molecules in the vicinity of the upper surface and the lower surface of the liquid crystal layer are subject to the respective orientation-regulating forces for aligning them in particular azimuth angle directions, respectively, and thus the directions do not change as the thickness of the liquid crystal layer changes. Therefore, the number of helical turns of the helical structure of the liquid crystal layer cannot change continuously. On the other hand, the local alignment direction of the liquid crystal molecules of the liquid crystal layer having the helical structure takes the same direction for every half a helical turn. Thus, as the thickness of the liquid crystal layer changes, the number of helical turns changes discontinuously by 0.5 (half a turn).

Therefore, when Δd, for two regions of the liquid crystal layer having different thicknesses, is less than a half of the helical pitch value (when Δd<0.5 P), the two regions may have the same number of helical turns, and thus the same value of the first threshold voltage. Thus, it may be possible that the liquid crystal layer included in one of the two regions cannot be transitioned to the focal conic state while maintaining the liquid crystal layer included in the other region in the planar state.

In contrast, with an arrangement such that the difference Δd between different values of the thickness d of the liquid crystal layer 30 satisfies the relationship of 0.5 P≦Δd with the helical pitch P of the helical structure, it is possible to more reliably ensure that a plurality of regions of the liquid crystal layer 30 having different thicknesses d have different values of the first threshold voltage. Therefore, it is possible to more reliably realize a display with a desired number of gray levels.

As described above, when a horizontal alignment layer is provided on both sides of the liquid crystal layer, the number of helical turns cannot change continuously as the thickness of the liquid crystal layer changes, whereby a region where the helical pitch is increased and a region where the helical pitch is reduced may exist in a pixel. It is believed that although there may be variations in the value of the helical pitch in a pixel and the value of the helical pitch may differ from the value of the spontaneous helical pitch that is set in the liquid crystal material forming the liquid crystal layer, the effects as described above may be obtained sufficiently as long as Δd is equal to or greater than a half the value of the spontaneous helical pitch.

The present embodiment has been described with respect to a case where the horizontal alignment layers 14 and 24 are provided on the opposing sides of the liquid crystal layer 30. A1ternatively, one of the horizontal alignment layers 14 and 24 may be a vertical alignment layer. With such an arrangement, the liquid crystal molecules of the liquid crystal layer are not subject to the orientation-regulating force on the surface of the vertical alignment layer, whereby the number of helical turns d/P can change continuously with the change in the thickness of the liquid crystal layer. Therefore, even if the value of Δd where the thickness d of the liquid crystal layer 30 changes discontinuously is less than a half the value of the helical pitch, a plurality of regions of the liquid crystal layer 30 having different values of the thickness d have different numbers of helical turns and different values of the first threshold voltage. Thus, it is easy to increase the number of gray levels by reducing the value of Δd. When one of the alignment layers provided on the opposing sides of the liquid crystal layer is a vertical alignment layer, the value of the helical pitch is substantially the same as the value of the spontaneous helical pitch.

The present embodiment has been described with respect to a liquid crystal display device capable of performing a display with five gray levels. However, the number of gray levels is not limited to five, but may be set to any desired number of gray levels. Where the number of gray levels is relatively small, it is possible to realize an intermediate gray level display that can be viewed by human eyes with no incongruous appearance, if regions of the same value of the first threshold voltage are distributed discretely in each pixel.

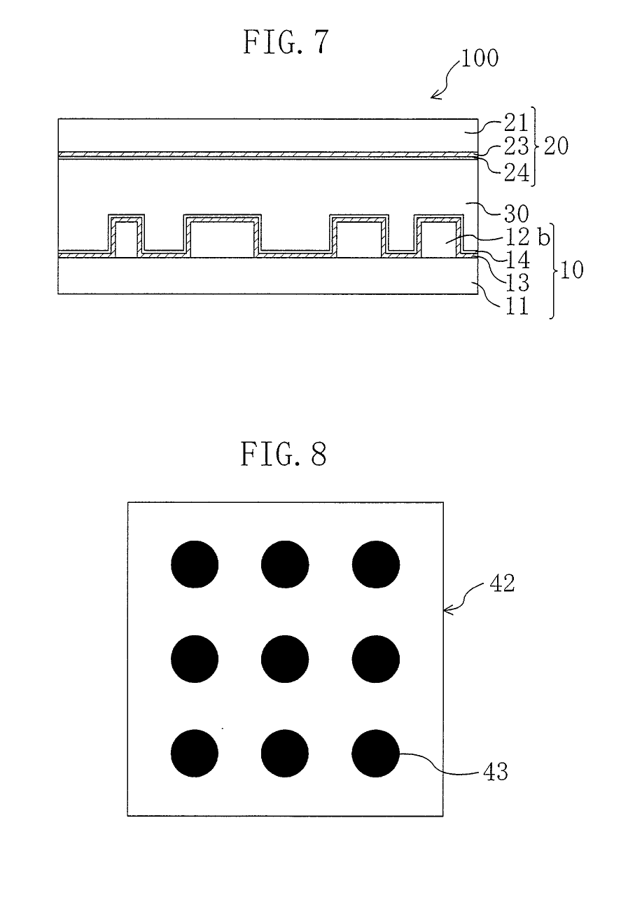

For example, in a case of a liquid crystal display device capable of performing a three gray level display, the effects as described above can be obtained by forming a plurality of resin layer portions 12b in each pixel in a discrete (island-like) pattern, as illustrated in FIG. 7. The resin layer portions 12b described above can be formed by, for example, a photolithography process using the photomask 42 including a plurality of light blocking portions 43 in each region corresponding to a pixel, as illustrated in FIG. 8. The shape of each light blocking portion 43 of the photomask 42 may be a circular shape, as illustrated in FIG. 8, or may alternatively be a polygonal shape.

Embodiment 2

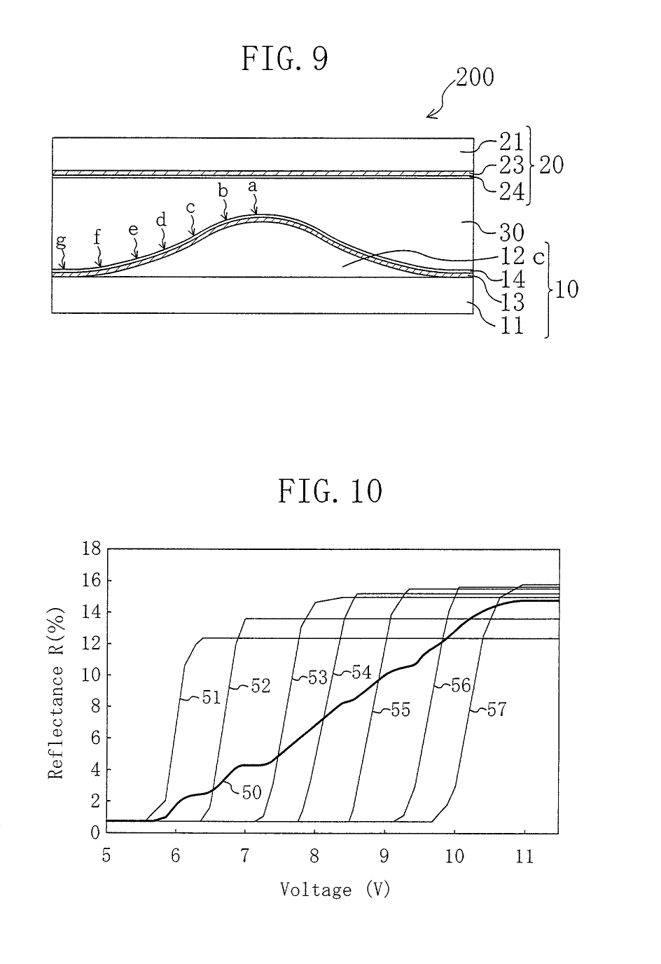

FIG. 9 schematically illustrates a liquid crystal display device 200 according to Embodiment 2 of the present invention. The liquid crystal display device 200 is different from the liquid crystal display device 100 in that the former includes a resin layer 12c provided on the liquid crystal layer side of the first substrate 10 in a continuous wavy shape. In subsequent figures, each element having substantially the same function as the corresponding element in the liquid crystal display device 100 will be denoted by the same reference numeral and will not be further described below.

In the liquid crystal display device 200, the resin layer 12c provided on the liquid crystal layer side of the first substrate 10 is formed in a continuous wavy shape, with the thickness d of the liquid crystal layer 30 changing continuously across a pixel. With such an arrangement where the thickness d of the liquid crystal layer changes continuously, it is easy to increase the number of gray levels. This will now be described in greater detail.

First, where a horizontal alignment layer is provided on both sides of the liquid crystal layer 30, the number of helical turns changes discontinuously by 0.5 as the thickness d of the liquid crystal layer 30 changes continuously. Therefore, irrespective of the steepness of the gradient of the resin layer 12c, there exist a plurality of regions each having a number of helical turns that is different from that of the next region by 0.5, and these regions have different values of the first threshold voltage of the liquid crystal layer 30. Therefore, it is not necessary, in the production process, to control the change in the thickness d of the liquid crystal layer 30 across a pixel with a high precision according to the helical pitch, whereby it is easy to increase the number of gray levels. FIG. 10 is a graph illustrating the reflectance of a pixel of the liquid crystal display device 200 in which a horizontal alignment layer is provided on both sides of the liquid crystal layer 30 along the vertical axis, and the voltage applied across the liquid crystal layer 30 along the horizontal axis. Solid lines 51, 52, 53, 54, 55, 56 and 57 in FIG. 10 respectively represent the reflectance in regions a, b, c, d, e, f and g in FIG. 9, with a solid line 50 representing the reflectance of one pixel as a whole.

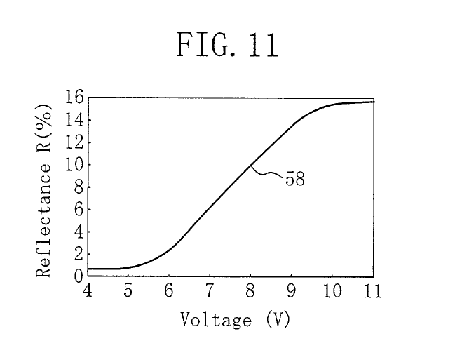

When one of the alignment layers provided on the opposing sides of the liquid crystal layer 30 is a vertical alignment layer, the number of helical turns continuously changes along with the continuous change in the thickness of the liquid crystal layer 30. Therefore, it is possible to further increase the number of gray levels, and the value of the reflectance continuously changes according to the continuous change in the value of the applied voltage, whereby it is possible to realize a substantially step-less gray level display. FIG. 11 is a graph illustrating the reflectance of a pixel of the liquid crystal display device 200 in which one of the alignment layers provided on the opposing sides of the liquid crystal layer 30 is a vertical alignment layer along the vertical axis, and the voltage applied across the liquid crystal layer 30 along the horizontal axis. A solid line 58 in FIG. 11 represents the reflectance of one pixel as a whole.

The resin layer 12c having a continuous wavy shape provided in the liquid crystal display device 200 of Embodiment 2 can be formed by, for example, forming a stepped resin layer as in the formation of the resin layer 12a provided in the liquid crystal display device 100 of Embodiment 1, and then further applying a resin material (e.g., OFPR-800 manufactured by Tokyo Ohka Kogyo Co., Ltd.) by a spin coat method. A1ternatively, the resin layer 12c may be formed by forming a stepped resin layer and subjecting the resin layer to a heat treatment at about 20° C. for about 60 minutes so that the resin layer is deformed through a heat deformation phenomenon.

In Embodiment 2, the pixel electrode 13 is formed on the resin layer 12c having a continuous wavy shape that is formed as described above. Since the resin layer 12c has no surface parallel to the substrate normal direction, the electrode material for forming the pixel electrode 13 can be applied thereon more uniformly, thereby suppressing the possibility of disconnection occurring in the pixel electrode 13.

Embodiments 1 and 2 have been described with respect to a case where the resin layer is provided on the first substrate 10, which is provided on the reverse side of the device. Of course, the present invention is not limited thereto, but the resin layer may alternatively be provided on the second substrate 20, which is provided on the viewer side of the device.

Embodiment 1 has been described with respect to a case where the thickness d of the liquid crystal layer 30 changes discontinuously across a pixel, and Embodiment 2 has been described with respect to a case where the thickness d of the liquid crystal layer 30 changes continuously across a pixel. The present invention is not limited thereto, but each of a plurality of pixels may alternatively include a region where the thickness d of the liquid crystal layer 30 changes discontinuously and another region where it changes continuously.

Embodiment 3

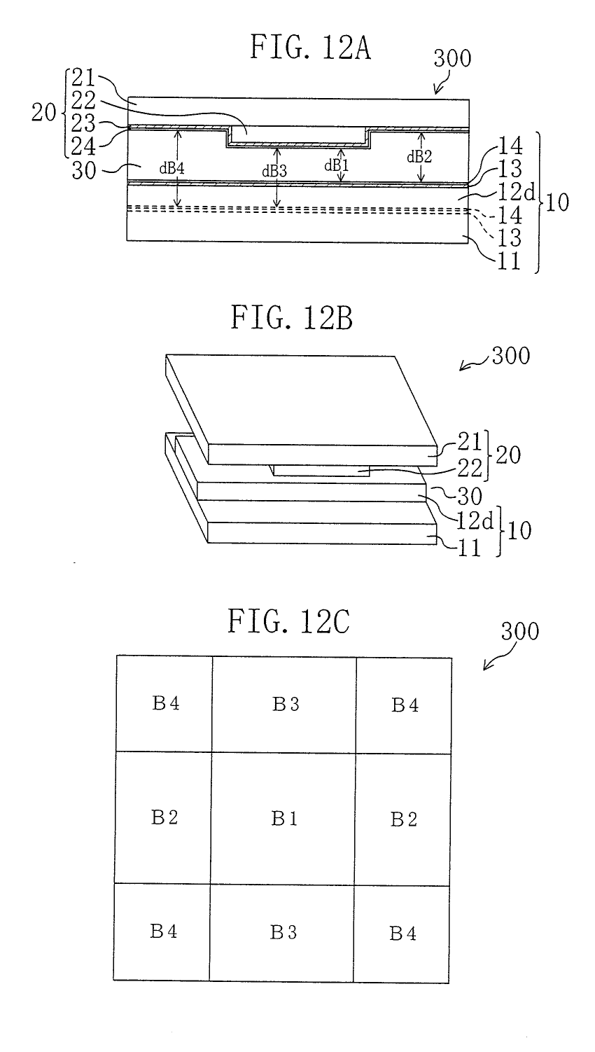

FIGS. 12A, 12B and FIG. 12C schematically illustrate a liquid crystal display device 300 according to Embodiment 3 of the present invention. FIG. 12A is a cross-sectional view illustrating a one-pixel portion of the liquid crystal display device 300 according to Embodiment 3 of the present invention, FIG. 12B is a perspective view thereof, and FIG. 12C is a top view thereof. The liquid crystal display device 300 is different from the liquid crystal display device 100 in that the former has a concave/convex surface on each of the first substrate 10 and the second substrate 20. In these figures, each element having substantially the same function as the corresponding element in the liquid crystal display device 100 will be denoted by the same reference numeral and will not be further described below.

In the liquid crystal display device 300, the first substrate 10 and the second substrate 20 interposing the liquid crystal layer 30 therebetween both have a concave/convex surface on one side thereof that is closer to the liquid crystal layer 30, as illustrated in FIG. 12A and FIG. 12B. With such an arrangement, the thickness d of the liquid crystal layer 30 is defined by the concave/convex surfaces of the first substrate 10 and the second substrate 20, whereby it is possible to realize a larger number of gray levels with fewer production steps. Thus, it is possible to simplify the production process (by reducing the number of production steps), and thus to reduce the production cost of a liquid crystal display device. This will now be described in greater detail by way of example.

In the liquid crystal display device 300 of the present invention, a resin layer 12d having a stripe pattern is provided on the insulative substrate 11, as illustrated in FIGS. 12A and 12B. Provided on transparent substrate 20 is a resin layer 22 also having a stripe pattern that crosses the stripe pattern of the resin layer 12d. In the present embodiment, the resin layers 12d and 22 are formed to thicknesses of about 6 μm and about 3 μm, respectively, by using a method as that used for providing the resin layer 12a in the liquid crystal display device 100 of Embodiment 1.

In the liquid crystal display device 300 having the resin layers 12d and 22 as described above, the liquid crystal layer 30 includes, in one pixel, regions B1, B2, B3 and B4 having different thicknesses of the liquid crystal layer 30, as illustrated in FIG. 12C, and the values of the thicknesses d_{B1}, d_{B2}, d_{B3} and d_{B4} of the liquid crystal layer 30 in the regions B1, B2, B3 and B4 are about 6 μm, about 9 μm, about 12 μm and about 15 μm, respectively. Thus, the liquid crystal display device 300 realizes a five gray level display.

On the other hand, in a liquid crystal display device in which resin layers each having the same thickness as the resin layers 12d and 22 are layered on one another in a stepped pattern, the liquid crystal layer includes, in one pixel, regions of the liquid crystal layer having thicknesses of about 6 μm, about 9 μm and about 15 μm, thereby realizing a four gray level display.

While the liquid crystal display device 300 of the present invention and the liquid crystal display device described above are produced through substantially the same number of production steps, the liquid crystal display device 300 realizes a display with more gray levels as described above. Thus, with the liquid crystal display device 300 of the present invention, a display with a predetermined number of gray levels can be realized with a smaller number of production steps. As a result, it is possible to simplify the production process (by reducing the number of production steps), and thus to reduce the production cost of a liquid crystal display device.

The embodiments above have been described with respect to a case where the thickness d of the liquid crystal layer is substantially defined by the resin layer provided on the substrate. However, the present invention is not limited thereto, but may take any other arrangement as long as it has a plurality of different values of the thickness d of the liquid crystal layer in each pixel.

In the embodiments described above, the resin layer is formed by a photolithography process using a photosensitive resin. The method and material for the formation of the resin layer are not limited thereto. When the resin layer is formed by photolithography process using a photosensitive resin as in the embodiments described above, it is possible to easily and reproducibly control the shape of the concave/convex surface.

In the embodiments described above, a liquid crystal material whose selective reflection region is set to be in the infrared region is used as the liquid crystal material of the liquid crystal layer 30. Of course, a liquid crystal material whose selective reflection region is set to be in the visible light region may alternatively be used. When the selective reflection region is in the infrared region, an image is displayed by scattering visible light, whereby it is possible to realize a black and white display of an image close to that on a sheet of paper. When the selective reflection region is in the visible light region, it is possible to easily realize a color display by, for example, layering together three liquid crystal cells whose selective reflection regions are set to be in wavelength regions corresponding to red, green and blue, respectively.

As described above, the present invention provides a liquid crystal display device capable of performing an intermediate gray level display and a multiple gray level display. The present invention can be suitably used with a liquid crystal display device including a liquid crystal layer having a helical structure, a bistability, and a memory property.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention that fall within the true spirit and scope of the invention.

What is claimed is:

1. A liquid crystal display device, comprising: a liquid crystal layer; a pair of substrates provided so as to interpose the liquid crystal layer therebetween; and a plurality of pixels arranged in a matrix pattern, wherein:
the liquid crystal layer has a helical structure and exhibits at least two stable states including a planar state and a focal conic state according to an applied voltage; and
in each of the plurality of pixels, a thickness d of the liquid crystal layer has at least two different values, and the liquid crystal layer includes at least two regions having different values of a first threshold voltage for transitioning the liquid crystal layer from the planar state to the focal conic state.

2. The liquid crystal display device of claim 1, wherein the thickness d of the liquid crystal layer satisfies a relationship of 1<d/P<15 with a helical pitch P of the helical structure.

3. The liquid crystal display device of claim 1, wherein the thickness d of the liquid crystal layer is defined so that VthFmax is less than VthHmin in each of the plurality of pixels, where VthFmax denotes the first threshold voltage for transitioning the liquid crystal layer included in a region with a largest thickness d of the liquid crystal layer from the planar state to the focal conic state, and VthHmin denotes a second threshold voltage for transitioning the liquid crystal layer included in a region with a smallest thickness d of the liquid crystal layer from the focal conic state to a homeotropic state.

4. The liquid crystal display device of claim 1, wherein a value of the thickness d of the liquid crystal layer changes discontinuously across each of the plurality of pixels.

5. The liquid crystal display device of claim 4, wherein a difference Δd between the at least two different values of the thickness d of the liquid crystal layer satisfies a relationship of 0.5 P≦Δd with the helical pitch P of the helical structure.

6. The liquid crystal display device of claim 1, wherein a value of the thickness d of the liquid crystal layer changes continuously across each of the plurality of pixels.

7. The liquid crystal display device of claim 1, further comprising a pair of alignment layers provided respectively on the pair of substrates on one side thereof that is closer to the liquid crystal layer, wherein one of the pair of alignment layers is a horizontal alignment layer, and the other one of the pair of alignment layers is a vertical alignment layer.

8. The liquid crystal display device of claim 1, wherein at least one of the pair of substrates includes a concave/convex surface on one side thereof that is closer to the liquid crystal layer.

9. The liquid crystal display device of claim 1, wherein the pair of substrates both include a concave/convex surface on one side thereof that is closer to the liquid crystal layer.
